(19) United States
(12) Patent Application Publication
(10) Pub. No.: US 2021/0160581 A1
(43) Pub. Date: May 27, 2021

(54) METHOD AND DATA PROCESSING APPARATUS

(71) Applicant: SONY CORPORATION, Tokyo (JP)

(72) Inventor: Renaud DIFRANCESCO, London (GB)

(73) Assignee: SONY CORPORATION, Tokyo (JP)

(21) Appl. No.: 17/046,219

(22) PCT Filed: Mar. 11, 2019
(86) PCT No.: PCT/EP2019/056056

§ 371 Date: Oct. 8, 2020

(30) Foreign Application Priority Data
Apr. 18, 2018 (GB) 1806325.5

(51) Int. Cl. H04N 21/488; G10L 25/63; G06K 9/00; H04N 21/439; H04N 21/44

(52) U.S. Cl. CPC H04N 21/4884; G10L 25/63; H04N 21/44008; H04N 21/4394; G06K 9/00315

(57) ABSTRACT

A method of generating an emotion descriptor icon includes receiving input content comprising video information, and performing analysis on the input content to produce information representing the video information with respect to a plurality of characteristics. The method also includes determining, based on a comparison of the information representing the video information at a temporal position in the video information and a set of information items respectively representing an emotion state, a relative likelihood of association between the input content and at least some of a plurality of emotion states, selecting an emotion state based on the outcome of the determination, and outputting an emotion descriptor icon selected from an emotion descriptor icon set comprising a plurality of emotion descriptor icons. The outputted emotion descriptor icon is associated with the selected emotion state.

### TECHNICAL FIELD OF THE DISCLOSURE

The present disclosure relates to methods and apparatuses for generating an emotion descriptor icon.

The present application claims the Paris Convention priority of United Kingdom patent application number 1806325.5, the contents of which are hereby incorporated by reference.

### BACKGROUND OF THE DISCLOSURE

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

Emotion icons, also known by the portmanteau emoticons, have existed for several decades. These are typically entirely text and character based, often using letters, punctuation marks and numbers, and include a vast number of variations. This vary by region, with Western style emoticons typically being written at a rotation of 90° anticlockwise to the direction of the text and

Japanese style emoticons (known as Kaomojis) being written with the same orientation as the text. Examples of Western emoticons include :-) (a smiley face), :( (a sad face, without a nose) and :-P (tongue out, such as when “blowing a raspberry”), while example Kaomojis include (\hat{ }_\hat{ }) and (T_T) for happy and sad faces respectively. Such emoticons became widely used following the advent and proliferation of SMS and the internet in the mid to late 1990s, and were (and indeed still are) commonly used in emails, text messages and in internet forums.

More recently, emojis (from the Japanese e (picture) and moji (character)) have become widespread. These originated around the turn of the 21^{st} century, and are much like emoticons but are actual pictures or graphics rather than typographics. Since 2010, emojis have been encoded in the Unicode Standard (starting from version 6.0 released in October 2010) which has such allowed their standardisation across multiple operating systems and widespread use, for example in instant messaging platforms.

One major issue is the discrepancy between the rendering of the otherwise standardised Unicode system for emojis, which is left to the creative choice of designers. Across various operating systems, such as Android, Apple, Google etc., the same Unicode for an emoji may be rendered in an entirely different manner. This may mean that the receiver of an emoji may not appreciate or understand the nuances or even meaning of that sent by a user of a different operating system.

In view of this, there is a need for an effective and standardised way of extracting a relevant emoji from text, video or audio, which can convey the same meaning and nuances, as intended by the originator of that text, video or audio, to users of devices having a range of operating systems.

### SUMMARY OF THE DISCLOSURE

The present disclosure can help address or mitigate at least some of the issues discussed above.

According to an example embodiment of the present disclosure there is provided a method of generating an emotion descriptor icon. The method comprises receiving input content comprising video information, performing analysis on the input content to produce information representing the video information with respect to a plurality of characteristics, determining, based on a comparison of the information representing the video information at a temporal position in the video information and a set of information items respectively representing an emotion state, a relative likelihood of association between the input content and at least some of a plurality of emotion states, selecting an emotion state based on the outcome of the determination, and outputting an emotion descriptor icon selected from an emotion descriptor icon set comprising a plurality of emotion descriptor icons, the outputted emotion descriptor icon being associated with the selected emotion state. In some embodiments, the method may further comprise, after outputting the emotion descriptor icon, outputting timing information associating the output emotion descriptor icon with a temporal position in the video information.

Various further aspects and features of the present technique are defined in the appended claims, which include a data processing apparatus, a television receiver, a tuner, a set top box, a transmission apparatus and a computer program, as well as circuitry for the data processing apparatus.

It is to be understood that the foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 provides an example of a data processing apparatus configured to carry out an emotion descriptor icon generation process in accordance with embodiments of the present technique;

FIG. 2A shows an example of a common time-line for identifying speakers in a piece of input content in accordance with embodiments of the present technique;

FIG. 2B shows an example of how data may be ascertained and analysed by a data processing system from a piece of input content in accordance with embodiments of the present technique;

FIG. 3 shows an example of how emojis may be selected on the basis of the analysis performed on input content by a data processing system such as that described by FIG. 2B in accordance with embodiments of the present technique; and

FIG. 4 shows an example of a flow diagram illustrating a process of generating an emotion descriptor icon carried out by a data processing system in accordance with embodiments of the present technique.

### DESCRIPTION OF EXAMPLE EMBODIMENTS

### Emotion Descriptor Icon Generation Data Processing Apparatus

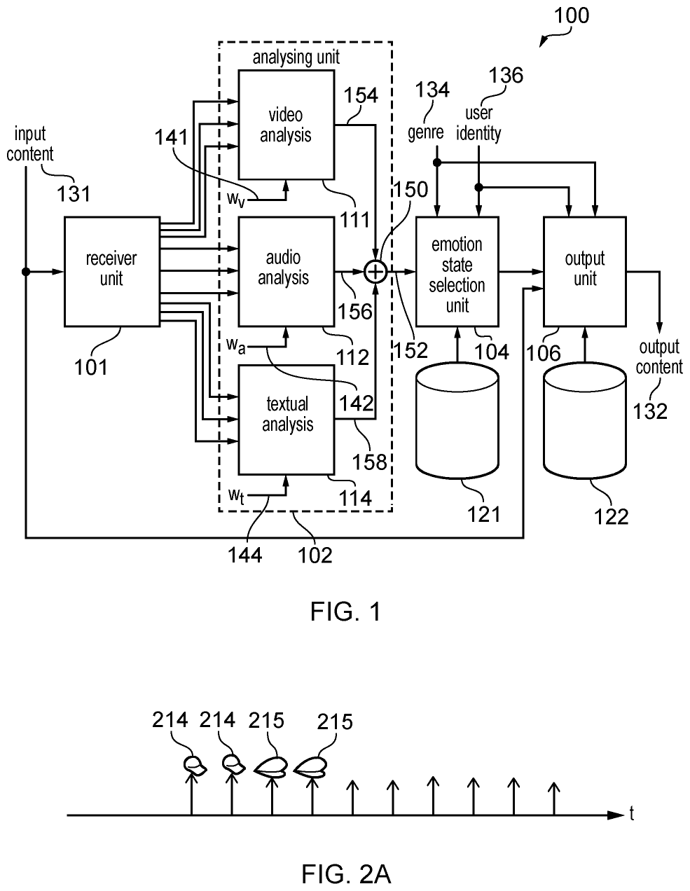

FIG. 1 shows an example data processing apparatus 100, which is configured to carry out an emotion descriptor icon generation process, in accordance with embodiments of the present technique. The data processing apparatus 100 comprises a receiver unit 101 configured to receive input content 131 comprising one or more of video information, audio information and textual information, an analysing unit 102 configured to perform analysis on the input content 131 to produce a vector signal 152 which aggregates the one or more of the video information, the audio information and the textual information in accordance with individual weighting values 141, 142 and 144 applied to each of the one or more of the video information, the audio information and the textual information, an emotion state selection unit 104 configured to determine, based on the vector signal 152, a relative likelihood of association between the input content 131 and each of a plurality of emotion states in a dynamic emotion state codebook, and to select the emotion state having the highest relative likelihood of all emotion states in the dynamic emotion state codebook, and an output unit 106 configured to output content 132 comprising the received input content 131 appended with an emotion descriptor icon (also herein referred to and to be understood as an emotion descriptor, an emoticon or an emoji) selected from an emotion descriptor icon set comprising a plurality of emotion descriptor icons, the outputted emotion descriptor icon being associated with the selected emotion state.

The receiving unit 101, upon receiving the input content 131, is configured to split the input content into separate parts. In the example shown in FIG. 1, these parts are video information, audio information and textual information, and are supplied by the receiving unit 101 to the analysing unit 102. It should be appreciated that the receiving unit 101 may break down the input content 131 in a different way, into fewer or more parts (and may include other types of information such as still image information or the like), or may provide the input content 131 to the analysing unit in the same composite format as it is received. In other examples, the input signal 131 may not be a composite signal at all, and may be formed only of textual information or only of audio or video information, for example. Alternatively, the analysing unit 102 may perform the breaking down of the composite input signal 131 into constituent parts before the analysis is carried out.

In the example data processing apparatus 100 shown in FIG. 1, the analysing unit 102 may be formed of a plurality of sub-units each configured to analyse different parts of the received input content 131. These may include, but are not limited to, a video analysis unit 111 configured to analyse the video information of the input content 131, an audio analysis unit 112 configured to analyse the audio information of the input content 131 and a textual analysis unit 114 configured to analyse the textual information of the input content 131. The video information may comprise one or more of a scene, body language of one or more people in the scene and facial expressions of the one or more people in the scene. The audio information may comprise one or more of music, speech and sound effects. The textual information may comprise one or more of a subtitle, a description of the input content and a closed caption. Each of the video information, the audio information and the textual information may be individually weighted by weighting values 141, 142 and 144 such that one or more of the video information, the audio information and the textual information has more (or less) of an impact or influence on the selection of the emotion state and the emotion descriptor icon. These weighting values 141, 142 and 144 may be each respectively applied to the video information, the audio information and the textual information as a whole, or may be applied differently to the constituent parts of the video information, the audio information and the textual information, or the weighting may be a combination of the two. For example, the audio information may be weighted 142 heavier than the video information and the textual information, but of the constituent parts of the audio information, the weighting value 142 may be more heavily skewed towards speech rather than to music or sound effects.

The outputs 154, 156 and 158 of each of the sub-units (e.g. the video analysis unit 111, the audio analysis unit 112 and the textual analysis unit 114) of the analysing unit 102 are each fed into a combining unit 150 in the example data processing apparatus 100 of FIG. 1. The combining unit 150 combines the outputs 154, 156 and 158 to produce a vector signal 152, which is an aggregate of these outputs 154, 156 and 158. Once produced, this vector signal 152 is passed into the emotion state selection unit 104.

As described above, the emotion state selection unit 104 is configured to make a decision, based on the received vector signal 152 from the combining unit 150, of an emotion state (for example, happy, sad, angry, etc.) which is most descriptive of or associated with the input content 131 (i.e. has a highest relative likelihood of being so among the emotion states in the emotion state codebook). In some examples of the data processing apparatus 100 shown in FIG. 1, the emotion state selection unit 104 may further make the decision on the emotion state to select based on not only the received vector signal 152, but also on further inputs, such as a genre 134 of the input content 131 which is received as an input 134 to the emotion state selection unit 104. For example, a comedy movie may be more likely to be associated with happy or laughing emotion states, and so these may be more heavily weighted through the inputted genre signal 134. In some examples of the data processing apparatus 100 shown in FIG. 1, the emotion state selection unit 104 may further make the decision on the emotion state to select based on a user identity signal 136, which may pertain to an identity of the originator of the input content 131. For example, if two teenagers are texting each other using their smartphones, or talking on an internet forum or instant messenger, the nuances and subtext of the textual information and words they use may be vastly different to if businessmen and women were conversing using the same language. Different emotion states may be selected in this case. For example, when basing a decision of which emotion state is most appropriate to select for input content 131 which is a reply “Yeah, right”, the emotion state selection unit 104 may make different selections based on a user identity input 136. For the teenagers, the emotion state selection unit 104 may determine that the emotion state is sarcastic or mocking, while for the businesspeople, the emotion state may be more neutral, with the reply “Yeah, right” being judged to be used as a confirmation. In some arrangements, it may be that, dependent on the genre signal 134 and the user identity signal 136, only a subset of the emotion states may be selected from the emotion state codebook

Once the emotion state selection unit 104 has selected an emotion state having the highest relative likelihood among all the emotion states in the emotion state codebook, this is passed as an input to the output unit 106, along with the original input content 131. Based on known or learned correlations between various emotion states and various emojis or the like (emotion descriptor icons), the output unit 106 will select an appropriate emotion descriptor icon from the emotion descriptor icon set. Again, as above, in some examples of the data processing apparatus 100 shown in FIG. 1, the output unit 106 may further make the decision on the emotion descriptor icon to select based on the genre signal 134 and/or the user identity signal 136, as these are likely to vary in subtext, nuance and interpretation among genres and users. In some arrangements, it may be that, dependent on the genre signal 134 and the user identity signal 136, only a subset of the emoticon descriptor icons may be selected from the emoticon descriptor icon set.

The user identity, characterised by the user identity signal 136, may in some arrangements act as a non-linear filter, which amplifies some elements and reduces others. It thus performs a semi-static transformation of the reference neutral generator of emotion descriptors. In practical terms, the neutral generator produces emotion descriptors, and the user identity signal 136 “adds its touch” to it, thus transforming the emotion descriptors (for example, having a higher intensity, a lower intensity, a longer chain of symbols, or a shorter chain of symbols). In other arrangements, the user identity signal 136 is treated more narrowly as the perspective by way of which the emoji match is performed (i.e. a different subset of emotion descriptor icons may be used, or certain emotion descriptor icons have higher likelihoods of selection than others depending on the user identity signal 136.

The emotion state codebook is shown in the example of FIG. 1 as being stored in a first memory 121 coupled with the emotion state selection unit 104, and similarly the emotion descriptor icon set is shown in the example of FIG. 1 as being stored in a second memory 122 coupled with the output unit 106. Each of these memories 121 and 122 may be separate to the emotion state selection unit 104 and the output unit 106, or may be respectively integrated with the emotion state selection unit 104 and the output unit 106. Alternatively, instead of memories 121 and 122, the emotion state codebook and the emotion descriptor icon set could be stored on servers, which are operated by the same or a different operator to the data processing apparatus 100. It may be the case that one of the memories 121 and 122 is used for storing one of the emotion state codebook and the emotion descriptor icon set, and a server is used for storing the other. The memories 121 and 122 may be implemented as RAM, or may include long-term or permanent memory, such as flash memory, hard disk drives and/or ROM. It should be appreciated that emotion states and emotion descriptor icons may be updated, added or removed from the memories 121 and 122 (or servers), and this updating/adding/removing may be carried out by the operator of the data processing system 100 or by a separate operator.

Finally, the output unit 106 outputs content 132, which is formed of the input content 131 appended with the selected emotion descriptor icon. This appendage may in the form of a subtitle delivered in association with the input content 131, for example in the case of a movie or still image as the input content 131, or may for example be used at the end of (or indeed anywhere in) a sentence or paragraph, or in place of a word in that sentence or paragraph, if the input content 131 is textual, or primarily textual. The user can choose whether or not the output content 132 is displayed with the selected emotion descriptor icon. This appended emotion descriptor icon forming part of the output content 132 may be very valuable to visually or mentally impaired users, or to users who do not understand the language of the input content 131, in their efforts to comprehend and interpret the output content 132. In other examples of data processing apparatus in accordance with embodiments of the present technique, the selected emotion descriptor icon is not appended to the input/output content, but is instead comprises Timed Text Mark-up Language (TTML)-like subtitles which are delivered separately to the output content 132 but include timing information to associate the video of the output content 132 with the subtitle. In other examples, the selected emotion descriptor icon may be associated with presentation timestamps. The video may be broadcast and the emotion descriptor icons may be retrieved from an internet (or another) network connection.

As described above, embodiments of the present disclosure provide data processing apparatus which are operable to carry out methods of generating an emotion descriptor icon. According to one embodiment, such a method comprises receiving input content comprising video information, performing analysis on the input content to produce information representing the video information with respect to a plurality of characteristics, determining, based on a comparison of the information representing the video information at a temporal position in the video information and a set of information items respectively representing an emotion state, a relative likelihood of association between the input content and at least some of a plurality of emotion states, selecting an emotion state based on the outcome of the determination, and outputting an emotion descriptor icon selected from an emotion descriptor icon set comprising a plurality of emotion descriptor icons, the outputted emotion descriptor icon being associated with the selected emotion state. In some embodiments, the method may further comprise, after outputting the emotion descriptor icon, outputting timing information associating the output emotion descriptor icon with a temporal position in the video information.

According to another embodiment of the disclosure, there is provided a method comprising receiving input content comprising one or more of video information, audio information and textual information, performing analysis on the input content to produce a vector signal which aggregates the one or more of the video information, the audio information and the textual information in accordance with individual weighting values applied to each of the one or more of the video information, the audio information and the textual information determining, based on the vector signal, a relative likelihood of association between the input content and each of a plurality of emotion states in a dynamic emotion state codebook, selecting the emotion state having the highest relative likelihood of all emotion states in the dynamic emotion state codebook, and outputting output content comprising the received input content appended with an emotion descriptor icon selected from an emotion descriptor icon set comprising a plurality of emotion descriptor icons, the outputted emotion descriptor icon being associated with the selected emotion state. Circuitry configured to perform some or all of the steps of the method is within the scope of the present disclosure. Circuitry configured to send or receive information as input or output from some or all of the steps of the method is within the scope of the present disclosure.

In embodiments of the present technique the language of any audio, text or metadata accompanying the video may influence the emotion analysis. Here, the language detected forms an input to the emotion analysis. The language may be used to define the set of emotion descriptors, for example, each language has its own set of emotion descriptors or the language can filter a larger set of emotion descriptors. Some languages may be tied to cultures where the population one culture express fewer or more emotions than others. In embodiments of the present technique, the location of a user may be detected, for example, by GPS or geolocation, and that location may determine or filter a set of emotion descriptors applied to an item of content.

Data processing apparatuses configured in accordance with embodiments of the present technique, such as the data processing apparatus 100 of FIG. 1, carry out methods of determining relevant emojis to display along with both real-time and pre-recorded input content. For example, this input content might be video content, which may further be coupled with an audio track and subtitles/closed caption text. The processing performed on this input content can be grouped into three distinct stages. These are:
i. Performing real-time visual hierarchical tracking:
   a. This tracking is of a scene, people in the scene, speech (i.e. audio) S(t) and facial expressions (i.e. visual) V(t); and
   b. Process jointly extracted visual and audio expression signals V(t) and S(t), along with transcribed text and caption T(t);
ii. Searching from dynamic codebook of emotion states, indexed by index i, for the closest emotion state E(i*):
   a. Perform on each variable i: Min_d(E(i), S(t), V(t), T(t)); and
   b. Find i* by minimising this distance Min_d;
iii. From contextual knowledge of emotion states found up to time t, with C(t)=(E(0), E(1), . . . , E(t)), finding the best matching emoji (indexed by index j*, for example for Unicode) from all possible emojis j:
   a. MaxLikelihood(Emoji(t)=j|C(t)), maximised on index j, with optimal index solution denoted as j*.

The output of this processing emoji(t)=j* is then appended to the text segment T(t) of the input content, as an emotional qualifier applied to the words.

The number of emotion states, E(N), may be variable, and dynamically increased or reduced over time by modifying, adding or removing emotion states from the emotion state codebook. For example, a simple three state codebook may be used (happy, unhappy and neutral), or more complex emotion states (for example, confusion, anger, sarcasm) may be included within the codebook. This of course depends on the application. A number of different codebooks could be used, and depending on the application, any one of these may be selected. The distances between (the descriptors for) each of these emotion states and the real-time vector signal—W(t)=(S(t), V(t), T(t)) which aggregates the audio signal S(t) (which may be mono, stereo, or spatial, etc.), the visual signal V(t) (which may be 2D, or 3D, etc.) and the text segment applied to this portion of the video timeline T(t)—is pre-defined and known to the emotion state selection unit and output unit which together determine the best matching state and the best matching emoji for each received input signal.

In terms of the implementation of signal processing, a window between times t(k) and t(k+1) will typically be taken. The window in this case can be chosen to make sense, and be semantically consistent. A close-up on two speakers holding a conversation may last around 30 seconds, with the same qualifying subtitle staying unchanged during this interval. This window of time aggregates the sequence of vectors as a segment, Z(t(k),t(k+1))={W(T)/t=t(k), t(k)+1, . . . , t(k+1)}, and the best match may then be found between this Z(t(k),t(k+1)) and the candidate emotional states E(i) of the emotion state codebook. In some embodiments of the present technique a window in time can be defined as the time between the start and the end of a video shot or scene change.

After running step (ii) of the processing as described above until time t, a model for the emotional state at time t, or for time interval (window) [t(k),t(k+1)] has been found. From this stage, accumulated knowledge of previously determined and selected emotional states may be introduced, along with some notion of how the grammar of a sentence may influence the sentence and the appropriate emotional states for that sentence. Sentences are built with nouns, verbs, adjectives, etc. and can be modelled with statistical likelihoods (for example, Hidden Markov Models are used in speech with a lot of success). Machine learning can also be used to build up knowledge at the processing apparatus of how particular grammatical patterns and previously determined and selected emotional states may be used in the future selection of emotional states.

In step (iii) of the processing as described above, local emotional information extracted for [t(k), t(k+1)] may be combined with accumulated knowledge of emotional states up to that point, and a relevant emoji (which could be one emoji, multiple emojis or in some instances, no emojis at all) can be selected. Further editorially changeable programming functions may be included within the processing, for example to avoid too many repetitions, or cancelling emojis from the emotion descriptor icon set with likelihood scores too low so as they are unlikely to ever be selected.

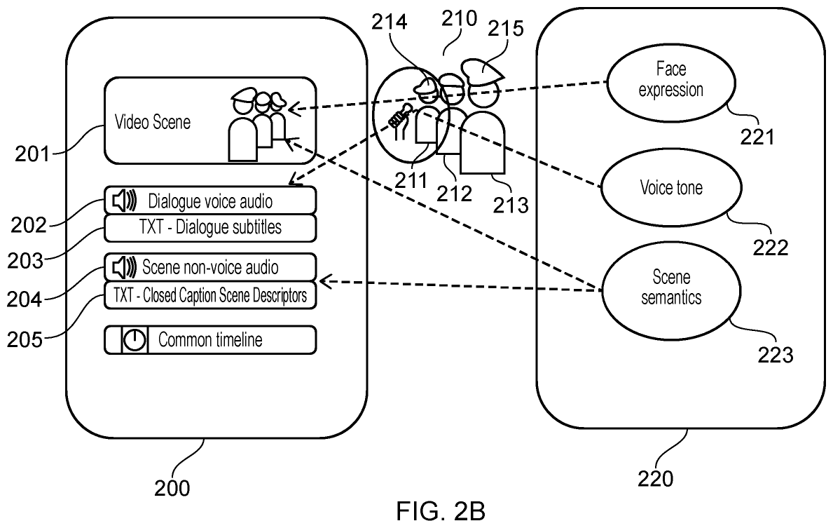

FIG. 2A shows an example of a common time-line for identifying speakers in a particular piece of input content (where the input content comprises video information as well as audio information and textual information), where active communication times among multiple speakers is identified, marked in a discrete manner, and followed. Here, at the first two points in time on the common time-line, the “teenager” character, denoted with the baseball cap 214, is speaking. At the third and fourth points in time on the common time-line, the “officer” character takes over the dialogue, denoted with the hat 215.

An example of the data ascertained from this time-line being used in an overall data processing system is shown in FIG. 2B. FIG. 2B shows the data processing take place in three distinct stages.

Firstly, in block 200, the input media content is formatted in terms of the data and the metadata it comprises. For example, the input media content from block 200 in the example of FIG. 2B is formatted into the video scene 201 itself, along with both audio, in terms of dialogue 202 and non-voice audio 204 in the scene and textual information, in terms of both subtitles 203 reciting the dialogue 202 and closed caption scene descriptors 205 describing the scene.

In section 210, the speaker tagging and tracking takes place, as described with respect to FIG. 2A. Here there are three characters, the “teenager” character 211 with the baseball cap 214 and the “officer” character 213 with the hat 215 as described in FIG. 2A, as well as a third character 212. The identifying, marking and following of each of these characters 211, 212 and 213 is carried out on the basis of the multiple signals available 201, 202 and 204 as well as on the textual information 203 and 205.

Block 220 is an emotion analysis engine, which is operable to scan the signals produced by each partaker 211, 213 in the conversation, and their text descriptions. It classifies them in sub-categories in view of determining the most likely emotional state and emoji determined therefrom. The emotion analysis engine 220 determines facial expression 221 from the video scene 201, using image processing and facial recognition techniques, and determines voice tone 222 from the dialogue 202 using speech recognition and signal processing techniques, as well as using lip reading techniques on the video scene 201 where appropriate. Scene semantics 223 are also determined from the video scene 201 and from the scene audio 204 and closed caption data 205 in order to determine subtext and mood, which can have a significant impact on the emotional state associated with a particular piece of input video content.

The emotion analysis engine 220, as described above, performs analysis on the input content to produce information representing the video information with respect to a plurality of characteristics. Based on a comparison of this information representing the video information with a set of information items respectively representing an emotion state, a relative likelihood of association between the input content and at least some of a plurality of emotions states may be determined. These steps are described in further detail in the following two paragraphs.

In some embodiments of the present technique, the emotion analysis may be conducted in accordance with a tone of voice in audio information or an audio track associated with the video information. In some embodiments of the present technique, the analysis may be conducted in accordance with the nature of any music or soundtrack associated with the video information. The analysis may involve the identification the particular piece of music based on, for example, an audio summary of frequency trough and peaks in the music and their relative positions. That particular piece of music may be associated with metadata which defines an emotion for example belligerent, sad, active, etc. The metadata may be textual data. The analysis in some embodiments of the present technique may be conducted with respect to vocabulary used or with respect to grammatical structures, for example a complex series of statements may lead to the emotion “bemused”, use of the imperative in a grammatical structure may imply some kind of order which is associated with an emotion, such as belittlement or harshness on behalf of the speaker using the imperative voice. In some embodiments of the present technique, the analysis may involve the detection of emotion from the content of a video scene. This may be achieved by segmenting the video to identify actions or changes in proximity between people or animals such as a fight, characters threatening each other with weapons (in which case the segmentation may identify an object such as a pistol), stroking or kissing (expressions of tenderness as an emotion), body language such as pointing (anger) or shrugging (bemusement) or retreat or folding of arms or leading backwards on a chair (relaxed). Background of scenes may be detected and used to derive emotions, for example, a beach scene may imply relaxation, or a busy scene comprising a large amount of traffic may imply stress.

In some embodiments of the present technique, the video information may depict two or more actors in conversation. When subtitles are generated for the two actors for simultaneous display, they may be differentiated from one another by being displayed in different colours or respective positions some other distinguishing attribute. Similarly, emotion descriptors may be assigned or associated with different attributes such as colours or display co-ordinates. Each actor in the conversation may express a different emotion at much the same time and using the attributes it should be easy for a viewer to determine which emotion descriptor is associated with which actor. In some embodiments of the present technique, the circuitry may determine that more than one emotion descriptor is appropriate at a single point in time. For example, an actor may express his fury vociferously or pent up fury may be expressed more silently (for example a descriptor representing steam coming from the ears). In this case, two or emotion descriptors may be displayed contemporaneously, for example with one helping to describe another such, as a descriptor displaying an angry red face and another waving their arms around. In some embodiments of the present technique, the emotion descriptors may be displayed in spatial isolation from any textual subtitle or caption. In some embodiments of the present technique, the emotion descriptors may be displayed within the text of the subtitle or caption. In some embodiments of the present technique, the emotion descriptors may be rendered as Portable Network Graphics (PNG Format) or another format in which graphics may be richer than simple text or ASCII characters.

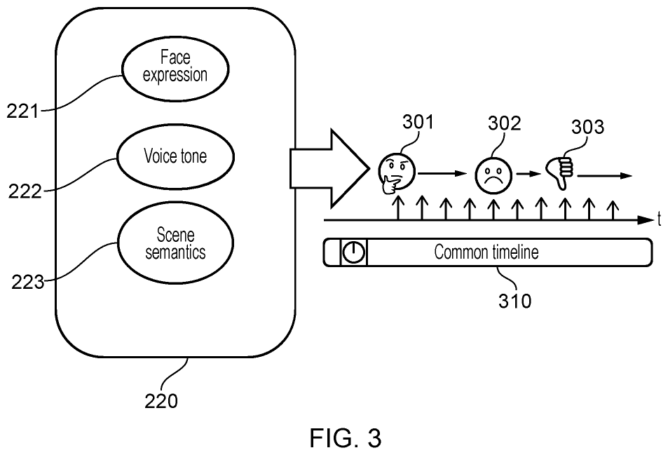

FIG. 3 shows an example of how emojis may be selected on the basis of the analysis performed on input content by a data processing system such as that described by FIG. 2B in accordance with embodiments of the present technique. In embodiments of the present technique, there are two distinct variant arrangements in which the emojis can be generated.

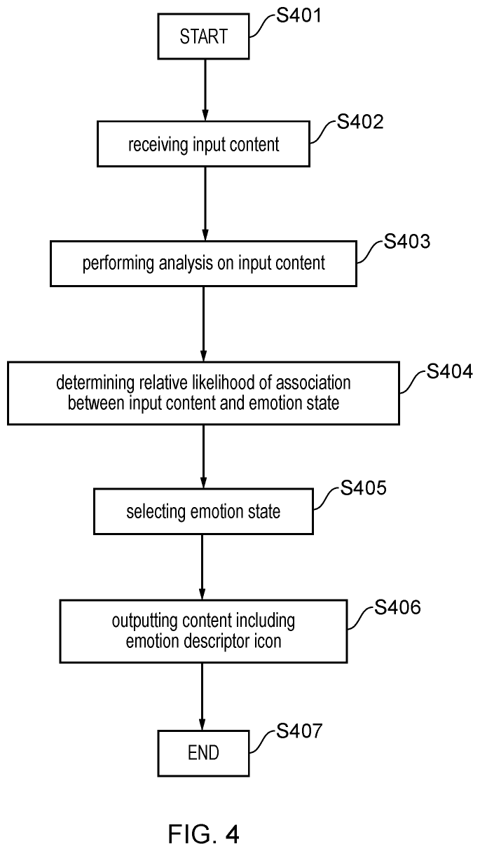

The first of these is spot-emoji generation, in which there is no-delay, instant selection at each time t over a common timeline 310 of the best emoji e*(t) from among all the emoji candidates e. As shown in FIG. 3, emojis 301, 302 and 303 are sequentially selected. According to the spot-emoji generation arrangement, each of these are selected instantaneously at each given time interval t. In order to do this, a machine learning algorithm used by the data processing apparatus for selecting the emoji e* is trained during a training phase on the mapping of {facial expression f(i), voice tone v(j), scene semantics s(k)}—as determined by the emotion analysis engine 220—to emoji e*(f(i),v(j),s(k)) for a labelled training set. In other words, with reference to at least the data processing apparatus of FIG. 1 as described above and the method as shown in FIG. 4 as described below, the steps of performing the analysis, determining the relative likelihood of association, selecting the emotion state and outputting the output content are performed each time there is a change in at least one of the one or more of the video information, the audio information and the textual information.

The second of these is emoji-time series generation, in which a selection is made at time t+N of the best emoji sequence e*(t), . . . , e*(t+N) among all candidate emojis e. As shown in FIG. 3, emojis 301, 302 and 303 are selected as the emoji sequence at time t+N. In order to carry out this arrangement, a machine learning algorithm used by the data processing apparatus for selecting the emoji e* is again trained during a training phase on the mapping of {facial expression segment of time length M, f(i,M), voice tone v(j,M), scene semantics s(k,M)}—as determined by the emotion analysis engine 220—to emoji sequence e*(f(i,M),v(j,M),s(k,M)) for a labelled training set of a time-series of length M. In other words, with reference to at least the data processing apparatus of FIG. 1 as described above and the method as shown in FIG. 4 as described below, the steps of performing the analysis, determining the relative likelihood of association, selecting the emotion state and outputting the output content are performed on the input content once for each of one or more windows of time in which the input content is received.

It should be noted by those skilled in the art that the spot-emoji determination arrangement corresponds to a word level analysis, whereas an emoji-time series determination corresponds to a sentence level analysis, and hence provides an increased stability and semantic likelihood among select emojis when compared to the spot-emoji generation arrangement. The time series works on trajectories (hence carrying memories and likelihoods of future transitions), whereas spot-emojis are simply isolated points of determination.

### Training Phase

The training phase for spot-emoji generation, in terms of how the emotion analysis engine 220 in the example data processing apparatus of FIG. 2B and FIG. 3 and the emotion state selection unit 104 and the output unit 106 of the data processing apparatus of FIG. 1 are programmed to operate is carried out as follows:
A training set is defined by combinations of facial expressions f(i), voice tones v(j), scene semantics s(k), where the training set is to be compared with candidate emojis e(l);
Scores are allocated to each combination of G(f(i),v(j),s(k),e(l));
In one implementation, human subjects are asked to allocate scores from 1 to 5, and only associations with scores of either 4 or 5 are retained. The averaging over the scores allocated by the human subjects yield Mean Opinion Scores (MOS) for each combination tested;
Following this, a second check is performed on these associations G(f(i),v(j),s(k),e(l)) to result in a function F associating each (f(i),v(j),s(k)) with a couple (e,p) where e is either an emoji e* or a void/nil element (i.e. for “no emoji”) and p is a likelihood value between 0 and 1 which reflects the score of the match to emoji e*; and
As a result, F(f(i),v(j),s(k))=(e,p) is obtained for a plurality of different facial expressions, voice tones, scene semantics and emojis from the set.

The training phase for emoji-time series generation, in terms of how the emotion analysis engine 220 in the example data processing apparatus of FIG. 2B and FIG. 3 and the emotion state selection unit 104 and the output unit 106 of the data processing apparatus of FIG. 1 are programmed to operate is carried out as follows:
A training set is defined by a time series in time t of combinations of facial expressions f(i,t), voice tones v(j,t), scene semantics s(k,t), where the training set is to be compared with candidate emojis e(l,t);
Scores are allocated to each combination of G(f(i,t),v(j,t),s(k,t),e(l,t)) when t runs from t₀ to t_{0+M};
In one implementation, human subjects are asked to allocate scores from 1 to 5, and only associations with scores of either 4 or 5 are retained. The averaging over the scores allocated by the human subjects yield Mean Opinion Scores (MOS) for each combination tested;
Following this, a second check is performed on these associations G(f(i,t),v(j,t),s(k,t),e(l,t)) to result in a function F associating each (f(i,t),v(j,t),s(k,t)) with a time series of couples (e(t),p(t)) where e(t) is either an emoji e* at time t or a void/nil element (i.e. for “no emoji”) at time t and p is a likelihood value between 0 and 1 which reflects the score of the match to emoji e* at time t; and
As a result, F(f(i,t),v(j,t),s(k,t))=(e(t),p(t)) is obtained for a plurality of different facial expressions, voice tones, scene semantics and emojis from the set, at time t running from t₀ to t_{0+M}.

Alternatively to the above described implementations of asking human subjects to score predetermined material, for both the spot-emoji generation and the emoji-time series generation, subjects in groups of, for example, 1 to 3 subjects, are asked to act in short scripted video sequences. In these sequences, the dialogues, text, scene descriptions and emotional qualifiers (i.e. emojis) have been defined. The recorded material, which now constitutes training material for the emoji generating data processing apparatuses of embodiments of the present technique, can be organised to define the matches as in the previous method of asking human subjects to score predetermined material. As a result, the function F(f(i,t),v(j,t),s(k,t))=(e(t), p(t)) is again obtained for time t running from t₀ to t_{0+M}.

It should be noted that, in this case p(t)=1, supposing that the acting is matching the script. However, in some implementations, a margin of uncertainty may be left, with p(t) being scored by a director dependent on the quality of acting in relation to the script.

Through such training, completeness and representativeness can be achieved. Speech algorithms can be trained on phonetically balanced set of sentences, and scripts which cover each representative use case of each emoji in the Unicode table, in all main flavours of emotion expression, can be used—in the same way as dictionaries work, by giving all categories of meaning and use of a word.

### Operational Phase

After the training phase, data processing apparatuses according to embodiments of the present technique are able to be operated in order to carry out processes as described above, and below in the appended claims.

As described above, in the training phase, the function F(f(i,t),v(j,t),s(k,t))=(e(t),p(t)) has been determined on a set of combinations (f(i,t),v(j,t),s(k,t)) for t in {t₀,t_{0+M}}. Such combinations are taken from the training set. The results are emojis and their respective relative likelihoods, for this type of context along dimensions (f, v, s).

The current sequences which may require determinations to be made by the data processing apparatus are now possibly outside of this training set, covering every possible combination cannot be reasonably achieved. Therefore, it is necessary to define a matching scheme between the observed sequence and the reference training sequences, and to select the closest emojis for each piece of input content. Classical pattern matching algorithms in vector spaces can be used, which are known in the art.

This leads to generating a set of (e*(t),p*(t)) of the emojis and their likelihood of closest neighbours (which are not necessarily unique). If (e*(t),p*(t)) has a clear centroid (e**(t), p**(t)), then this centroid can be used. Alternatively, if there is too much dispersion in the class of (e*(t),p*(t)) then the “no emoji” state is retained, in automated mode. However in a manual mode, the analysis of the segments where “no emoji” has been selected will lead to a selection of an emoji by a human expert, which will enhance the base of knowledge of the emoji generator. This will of course then decrease the likelihood of the same level of dispersion occurring in the class during future operation of the data processing system.

FIG. 4 shows an example of a flow diagram illustrating a process of generating an emotion descriptor icon carried out by a data processing system in accordance with embodiments of the present technique. The process starts in step S401. In step S402, the method comprises receiving input content comprising video information. In step S403, the method comprises performing analysis on the input content to produce information representing the video information with respect to a plurality of characteristics. The process then advances to step S404, which comprises determining, based on a comparison of the information representing the video information at a temporal position in the video information and a set of information items respectively representing an emotion state, a relative likelihood of association between the input content and at least some of a plurality of emotion states. In step S405, the process comprises selecting an emotion state based on the outcome of the determination. The method then moves to step S406, which comprises outputting an emotion descriptor icon selected from an emotion descriptor icon set comprising a plurality of emotion descriptor icons, the outputted emotion descriptor icon being associated with the selected emotion state. Step S406 may, in some arrangements, also comprise outputting timing information associating the output emotion descriptor icon with a temporal position in the video information. The process ends in step S407.

Data processing apparatuses as described above may be at the receiver side, or the transmitter side of an overall system. For example, the data processing apparatus may form part of a television receiver, a tuner or a set top box, or may alternatively form part of a transmission apparatus for transmitting a television program for reception by one of a television receiver, a tuner or a set top box.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fibre optic medium, etc. User input may include any combination of a keyboard, mouse, touch screen, voice command input, etc. User input may similarly be used to direct a browser application executing on a user's computing device to one or more network resources, such as web pages, from which computing resources may be accessed.

While the invention has been described in connection with specific examples and various embodiments, it should be readily understood by those skilled in the art that many modifications and adaptations of the embodiments described herein are possible without departure from the spirit and scope of the invention as claimed hereinafter. Thus, it is to be clearly understood that this application is made only by way of example and not as a limitation on the scope of the invention claimed below. The description is intended to cover any variations, uses or adaptation of the invention following, in general, the principles of the invention, and including such departures from the present disclosure as come within the known and customary practice within the art to which the invention pertains, within the scope of the appended claims.

Various further aspects and features of the present technique are defined in the appended claims. Various modifications may be made to the embodiments hereinbefore described within the scope of the appended claims.

The following numbered paragraphs provide further example aspects and features of the present technique:

Paragraph 1. A method of generating an emotion descriptor icon, the method comprising:
receiving input content comprising video information;
performing analysis on the input content to produce information representing the video information with respect to a plurality of characteristics;
determining, based on a comparison of the information representing the video information at a temporal position in the video information and a set of information items respectively representing an emotion state, a relative likelihood of association between the input content and at least some of a plurality of emotion states;
selecting an emotion state based on the outcome of the determination;
outputting an emotion descriptor icon selected from an emotion descriptor icon set comprising a plurality of emotion descriptor icons, the outputted emotion descriptor icon being associated with the selected emotion state; and
outputting timing information associating the output emotion descriptor icon with a temporal position in the video information.

Paragraph 2. A method according to Paragraph 1, wherein the video information comprises one or more of a scene, body language of one or more people in the scene and facial expressions of the one or more people in the scene.

Paragraph 3. A method according to Paragraph 1 or Paragraph 2, wherein the input content further comprises audio information comprises one or more of music, speech and sound effects.

Paragraph 4. A method according to any of Paragraphs 1 to 3, wherein the input content further comprises textual information comprises one or more of a subtitle, a description of the input content and a closed caption.

Paragraph 5. A method according to any of Paragraphs 1 to 4, wherein the steps of performing the analysis, determining the relative likelihood of association, selecting the emotion state and outputting the emotion descriptor icon are performed each time there is a change in the video information, or audio information of the input content or textual information of the input content.

Paragraph 6. A method according to any of Paragraphs 1 to 5, wherein the steps of performing the analysis, determining the relative likelihood of association, selecting the emotion state and outputting the emotion descriptor icon are performed on the input content once for each of one or more windows of time in which the input content is received.

Paragraph 7. A method according to any of Paragraphs 1 to 6, wherein the relative likelihood of association between the input content and the at least some of the emotion states is determined in accordance with a determined genre of the input content.

Paragraph 8. A method according to any of Paragraphs 1 to 7, wherein the relative likelihood of association between the input content and the at least some of the emotion states is determined in accordance with a determination of the identity or location of a user who is viewing the output content.

Paragraph 9. A method according to any of Paragraphs 1 to 8, wherein the plurality of emotion states are stored in a dynamic emotion state codebook.

Paragraph 10. A method according to Paragraph 9, comprising filtering the dynamic emotion state codebook in accordance with a determined genre of the input content, wherein the selected emotion state is selected from the filtered dynamic emotion state codebook.

Paragraph 11. A method according to Paragraph 9 or Paragraph 10, comprising filtering the dynamic emotion state codebook in accordance with a determination of the identity of a user who is viewing the output content, wherein the selected emotion state is selected from the filtered dynamic emotion state codebook.

Paragraph 12. A method according to any of Paragraphs 1 to 11, wherein the information representing the video information is a vector signal which aggregates the video information with audio information of the input content and textual information of the input content in accordance with individual weighting values applied to each of the one or more of the video information, the audio information and the textual information.

Paragraph 13. A data processing apparatus comprising:
a receiver unit configured to receive input content comprising video information;
an analysing unit configured to perform analysis on the input content to produce information representing the video information with respect to a plurality of characteristics;
an emotion state selection unit configured to determine, based on a comparison of the information representing the video information at a temporal position in the video information and a set of information items respectively representing an emotion state, a relative likelihood of association between the input content and at least some of a plurality of emotion states, and to select an emotion state based on the outcome of the determination; and
an output unit configured to output an emotion descriptor icon selected from an emotion descriptor icon set comprising a plurality of emotion descriptor icons, the outputted emotion descriptor icon being associated with the selected emotion state and to output timing information associating the output emotion descriptor icon with a temporal position in the video information.

Paragraph 14. A data processing apparatus according to Paragraph 13, wherein the video information comprises one or more of a scene, body language of one or more people in the scene and facial expressions of the one or more people in the scene.

Paragraph 15. A data processing apparatus according to Paragraph 13 or Paragraph 14, wherein the input content further comprises audio information comprises one or more of music, speech and sound effects.

Paragraph 16. A data processing apparatus according to any of Paragraphs 13 to 15, wherein the input content further comprises textual information comprises one or more of a subtitle, a description of the input content and a closed caption.

Paragraph 17. A data processing apparatus according to any of Paragraphs 13 to 16, wherein the analysing unit is configured to perform the analysis, the emotion state selection unit is configured to determine the relative likelihood of association and select the emotion state and the output unit is configured to output the emotion descriptor icon each time there is a change in the video information, or audio information of the input content or textual information of the input content.

Paragraph 18. A data processing apparatus according to any of Paragraphs 13 to 17, wherein the analysing unit is configured to perform the analysis, the emotion state selection unit is configured to determine the relative likelihood of association and select the emotion state and the output unit is configured to output the emotion descriptor icon once for each of one or more windows of time in which the input content is received.

Paragraph 19. A data processing apparatus according to any of Paragraphs 13 to 18, wherein the relative likelihood of association between the input content and the at least some of the emotion states is determined in accordance with a determined genre of the input content.

Paragraph 20. A television receiver comprising a data processing apparatus according to any of Paragraphs 13 to 19.

Paragraph 21. A tuner comprising a data processing apparatus according to any of Paragraphs 13 to 19.

Paragraph 22. A set top box for receiving a television programme, the set top box comprising a data processing apparatus according to any of Paragraphs 13 to 19.

Paragraph 23. A transmission apparatus for transmitting a television programme for reception by one of a television receiver, a tuner or a set-top box, the transmission apparatus comprising a data processing apparatus according to any of Paragraphs 13 to 19.

Paragraph 24. A computer program for causing a computer when executing the computer program to perform the method according to any of Paragraphs 1 to 12.

Paragraph 25. Circuitry for a data processing apparatus comprising:
receiver circuitry configured to receive input content comprising video information;
analysing circuitry configured to perform analysis on the input content to produce information representing the video information with respect to a plurality of characteristics;
emotion state selection circuitry configured to determine, based on a comparison of the information representing the video information at a temporal position in the video information and a set of information items respectively representing an emotion state, a relative likelihood of association between the input content and at least some of a plurality of emotion states, and to select an emotion state based on the outcome of the determination; and
output circuitry configured to output an emotion descriptor icon selected from an emotion descriptor icon set comprising a plurality of emotion descriptor icons, the outputted emotion descriptor icon being associated with the selected emotion state and to output timing information associating the output emotion descriptor icon with a temporal position in the video information.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments. Similarly, method steps have been described in the description of the example embodiments and in the appended claims in a particular order. Those skilled in the art would appreciate that any suitable order of the method steps, or indeed combination or separation of currently separate or combined method steps may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### RELATED ART

M. Ghai, S. Lal, S. Duggal and S. Manik, “Emotion recognition on speech signals using machine learning,” 2017 International Conference on Big Data Analytics and Computational Intelligence (ICBDAC), Chirala, 2017, pp. 34-39. doi: 10.1109/ICBDACI.2017.8070805
S. Susan and A. Kaur, “Measuring the randomness of speech cues for emotion recognition,” 2017 Tenth International Conference on Contemporary Computing (IC3), Noida, 2017, pp. 1-6. doi: 10.1109/103.2017.8284298
T. Kundu and C. Saravanan, “Advancements and recent trends in emotion recognition using facial image analysis and machine learning models,” 2017 International Conference on Electrical, Electronics, Communication, Computer, and Optimization Techniques (ICEECCOT), Mysuru, 2017, pp. 1-6. doi: 10.1109/ICEE000T.2017.8284512
Y. Kumar and S. Sharma, “A systematic survey of facial expression recognition techniques,” 2017 International Conference on Computing Methodologies and Communication (ICCMC), Erode, 2017, pp. 1074-1079. doi: 10.1109/ICCMC.2017.8282636
P. M. Müller, S. Amin, P. Verma, M. Andriluka and A. Bulling, “Emotion recognition from embedded bodily expressions and speech during dyadic interactions,” 2015 International Conference on Affective Computing and Intelligent Interaction (ACII), Xi'an, 2015, pp. 663-669. doi: 10.1109/ACII.2015.7344640
Francesco Barbieri, Miguel Ballesteros, Francesco Ronzano, Horacio Saggion, “Multimodal Emoji Prediction,” [Online], Available at: https://www.researchgate.net/profile/Francesco_Ronzano/publication/323627481_Multimodal_Emoji_Prediction/links/5aa2961245851543e63c1e60/Multimodal-Emoji-Prediction.pdf
Christa Dürscheid, Christina Margrit Siever, “Communication with Emojis,” [Online], Available at: https://www.researchgate.net/profile/Christa_Duerscheid/publication/315674101_Beyond_the_Alphabet_-_Communication_with_Emojis/links/58db98a9aca272967f23ec74/Beyond-the-Alphabet-Communication-with-Emojis.pdf

1.-25. (canceled)

26. A method of generating an emotion descriptor icon, the method comprising:
receiving input content comprising video information;
performing analysis on the input content to produce information representing the video information with respect to a plurality of characteristics;
determining, based on a comparison of the information representing the video information at a temporal position in the video information and a set of information items respectively representing an emotion state, a relative likelihood of association between the input content and at least some of a plurality of emotion states;
selecting an emotion state based on the outcome of the determination;
outputting an emotion descriptor icon selected from an emotion descriptor icon set comprising a plurality of emotion descriptor icons, the outputted emotion descriptor icon being associated with the selected emotion state; and
outputting timing information associating the output emotion descriptor icon with a temporal position in the video information.

27. The method according to claim 26, wherein the video information comprises one or more of a scene, body language of one or more people in the scene and facial expressions of the one or more people in the scene.

28. The method according to claim 26, wherein the input content further comprises audio information comprises one or more of music, speech and sound effects.

29. The method according to claim 26, wherein the input content further comprises textual information comprises one or more of a subtitle, a description of the input content and a closed caption.

30. The method according to claim 26, wherein the steps of performing the analysis, determining the relative likelihood of association, selecting the emotion state and outputting the emotion descriptor icon are performed each time there is a change in the video information, or audio information of the input content or textual information of the input content.

31. The method according to claim 26, wherein the steps of performing the analysis, determining the relative likelihood of association, selecting the emotion state and outputting the emotion descriptor icon are performed on the input content once for each of one or more windows of time in which the input content is received.

32. The method according to claim 26, wherein the relative likelihood of association between the input content and the at least some of the emotion states is determined in accordance with a determined genre of the input content.

33. The method according to claim 26, wherein the relative likelihood of association between the input content and the at least some of the emotion states is determined in accordance with a determination of the identity or location of a user who is viewing the output content.

34. The method according to claim 26, wherein the plurality of emotion states are stored in a dynamic emotion state codebook, the method comprising filtering the dynamic emotion state codebook in accordance with a determined genre of the input content or in accordance with a determination of the identity of a user who is viewing the output content, wherein the selected emotion state is selected from the filtered dynamic emotion state codebook.

35. The method according to claim 26, wherein the information representing the video information is a vector signal which aggregates the video information with audio information of the input content and textual information of the input content in accordance with individual weighting values applied to each of the one or more of the video information, the audio information and the textual information.

36. A data processing apparatus comprising circuitry configured to:
receive input content comprising video information;
perform analysis on the input content to produce information representing the video information with respect to a plurality of characteristics;
determine, based on a comparison of the information representing the video information at a temporal position in the video information and a set of information items respectively representing an emotion state, a relative likelihood of association between the input content and at least some of a plurality of emotion states, and to select an emotion state based on the outcome of the determination; and
output an emotion descriptor icon selected from an emotion descriptor icon set comprising a plurality of emotion descriptor icons, the outputted emotion descriptor icon being associated with the selected emotion state and to output timing information associating the output emotion descriptor icon with a temporal position in the video information.

37. The data processing apparatus according to claim 36, wherein the video information comprises one or more of a scene, body language of one or more people in the scene and facial expressions of the one or more people in the scene.

38. The data processing apparatus according to claim 36, wherein the input content further comprises audio information comprises one or more of music, speech and sound effects.

39. The data processing apparatus according to claim 36, wherein the input content further comprises textual information comprises one or more of a subtitle, a description of the input content and a closed caption.

40. The data processing apparatus according to claim 36, wherein the circuitry is configured to perform the analysis, determine the relative likelihood of association and select the emotion state and output the emotion descriptor icon each time there is a change in the video information, or audio information of the input content or textual information of the input content.

41. The data processing apparatus according to claim 36, wherein the circuitry is configured to perform the analysis, determine the relative likelihood of association and select the emotion state and output the emotion descriptor icon once for each of one or more windows of time in which the input content is received.

42. The data processing apparatus according to claim 36, wherein the relative likelihood of association between the input content and the at least some of the emotion states is determined in accordance with a determined genre of the input content.

43. A television receiver comprising a data processing apparatus according to claim 38.

44. A non-transitory storage medium comprising executable code components which, when executed on a computer, cause the computer to perform the method according to claim 26.

45. Circuitry for a data processing apparatus comprising:
receiver circuitry configured to receive input content comprising video information;
analysing circuitry configured to perform analysis on the input content to produce information representing the video information with respect to a plurality of characteristics;
emotion state selection circuitry configured to determine, based on a comparison of the information representing the video information at a temporal position in the video information and a set of information items respectively representing an emotion state, a relative likelihood of association between the input content and at least some of a plurality of emotion states, and to select an emotion state based on the outcome of the determination; and
output circuitry configured to output an emotion descriptor icon selected from an emotion descriptor icon set comprising a plurality of emotion descriptor icons, the outputted emotion descriptor icon being associated with the selected emotion state and to output timing information associating the output emotion descriptor icon with a temporal position in the video information.
